(19) United States
(12) Patent Application Publication
(10) Pub. No.: US 2008/0026151 A1
(43) Pub. Date: Jan. 31, 2008

(54) ADDITION OF SILANES TO COATING COMPOSITIONS

(76) Inventors: Danqing Zhu, Mason, OH (US); William J. Van Ooij, Fairfield, OH (US)

Correspondence Address: WOOD, HERRON & EVANS, LLP, 2700 CAREW TOWER, 441 VINE STREET, CINCINNATI, OH, 45202, US

(21) Appl. No.: 11/829,509

(22) Filed: Jul. 27, 2007

Related U.S. Application Data
(60) Provisional application No. 60/820,898, filed on Jul. 31, 2006.

(51) Int. Cl. B05D 3/00; C04B 41/50

(52) U.S. Cl. 427/327; 106/14.05; 106/287.1

(57) ABSTRACT

A coating composition for use on a cleaned but untreated metal surfaces includes a liquid polymerizable coating composition such as a urethane paint, or the like, blended with an organofunctional silane. The organofunctional silane can be a bis-functional monomeric or an oligomeric silane such as a silsesquioxane. The composition can be applied directly to an untreated metal surface. The silane in the coating composition improves adhesion of the coating composition and deters corrosion.

### RELATED APPLICATION

This application is related to and claims benefit of U.S. Provisional Patent Application Ser. No. 60/820,898, filed on Jul. 31, 2006, the disclosure of which is incorporated herein by reference.

### BACKGROUND OF THE INVENTION

In order to prevent rust and extend the useful life of products made from metal, the metal is generally treated or coated. The metal can be pretreated with various chemicals such as zirconium or chromium compounds, as well as phosphates. Silanes have also been used to pretreat metals. The pretreated metals can then be subjected to subsequent coating operations, in particular painting.

Pretreatment of the metal surfaces prior to painting improves the oxidation resistance of the metal article and adhesion of the coating to the metal surface.

Gamma aminopropyltriethoxysilane has been added to coatings to improve adhesion, but adding amino silanes to the coatings is not known to prevent corrosion on untreated metal surfaces. Further, silsesquioxanes provide thermal stability to coatings but, again, are not known to prevent corrosion on untreated metal surfaces.

### SUMMARY OF THE INVENTION

The present invention is premised on the realization that the pretreatment of a metal surface can be avoided by incorporating a silane into the polymeric coating composition. In particular, by incorporating a small percentage of monomeric organofunctional silanes or oligomeric organofunctional silanes into a polymeric coating such as a primer or clear coat, or the like, one can eliminate the need for pretreatment.

In particular, amino vinyl silane blends are useful in the present invention. Further, with respect to oligomers, organofunctional silsesquioxanes are particularly suitable for use in the present invention.

### DETAILED DESCRIPTION

According to the present invention, organofunctional silanes are added to coating compositions such as paints, primers, clear coats, and the like prior to application, to enhance the adhesion of the coating to the metal and to improve corrosion resistance. Although these can be applied to a pretreated metal surface, they are preferably applied to an untreated metal surfaces.

According to the present invention, any organic solvent or water dispersed polymerizable coating composition typically used to coat or paint metal can be used. These would include, primers, pigment containing paints, as well as clear coats. These are hereinafter referred to generically as polymeric coatings. Such polymeric coatings will include organic reactants or prepolymers dispersed or dissolved in a solvent or carrier, which, upon evaporation of the solvent or carrier, forms a polymerized coating over the surface of the metal. Typically, these polymeric coatings are polyurethanes, acrylates or methacrylates, or epoxies, although any polymeric coating typically used on metal surfaces is suitable for use in the present invention. The carrier or solvent for these coatings can be either organic solvents or water, or mixtures of, for example, water and alcohol.

The silane composition can be either hydrolyzed or unhydrolyzed. Suitable silanes include certain monomeric silanes as well as blends of monomeric silane and oligomeric silanes having a molecular weight of less than about 500, such as silsesquioxanes.

Typical organofunctional monomeric silanes used in these applications include amino silanes, vinyl silanes, bis-functional amino silanes, polysufide silanes, epoxy silanes, ureido silanes and isocyanato silanes, as well as mixtures thereof. Such silanes are disclosed in U.S. Pat. No. 6,416,869; U.S. Pat. No. 6,756,079; PCT application WOP2004/009717; pending application U.S. 2005/0058843; and U.S. Pat. No. t,919,469, the disclosures of which are hereby incorporated by reference.

Suitable monofunctional silanes include: vinylethoxysilane, gamma-methacryloxypropyltrimethoxysilane, gamma-glycidoxypropyltrimethoxysilane, gamma-ureidopropyltrimethoxysilane and gamma-isocyanatopropyltriethoxysilane.

In addition to using straight monomeric silanes, a mixture of monomeric silanes can be employed, in particular, a blend of aminosilane in combination with vinyl silane has been found to be particularly advantageous. A ratio of 5:1 volume/volume of bis-aminosilane and vinyl silane is particularly beneficial, as is discussed below.

Bis-silyl aminosilanes which may be employed in the present invention have two trisubstitued silyl groups, wherein the substituents are individually chosen from the group consisting of alkoxy, aryloxy and acyloxy. Thus, these bis-silyl aminosilanes have the general structure: 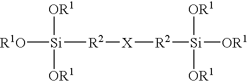
wherein each R¹ is chosen from the group consisting of: C₁-C₂₄ alkyl (preferably C₁-C₆ alkyl), and C₂-C₂₄ acyl (preferably C₂C₄ acyl). Each R¹ may be the same of different, however, in the hydrolyzed silane solutions, at least a portion (and preferably all of substantially all) of the R¹ groups are replaced by a hydrogen atom. Preferably, each R¹ is individually chosen from the group consisting of: ethyl, methyl, propyl, iso-propyl, butyl, iso-butyl, sec-butyl, ter-butyl and acetyl.

Each R² in the aminosilane may be a substituted or unsubstituted aliphatic group, or a substituted or unsubstituted aromatic group, and each R² may be the same or different. Preferably, each R² is chosen from the group consisting of: C₁-C₁₀ alkylene, C₁-C₁₀ alkenylene, arylene, and alkylarylene. More preferably, each R² is a C₁-C₁₀ alkylene (particularly propylene).
X may be: 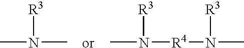
wherein each R³ may be a hydrogen, a substituted or unsubstituted aliphatic group, or a substituted or unsubstituted aromatic group, and each R³ is chosen from the group consisting of hydrogen, C₁-C₆ alkyl and C₁-C₆ alkenyl. More preferably, each R³ is a hydrogen atom.

Finally, R⁴ in the aminosilane(s) may be a substituted or unsubstituted aliphatic group, or a substituted or unsubstituted aromatic group. Preferably, R⁴ is chosen from the group consisting of: C₁-C₁₀ alkylene, C₁-C₁₀ alkenylene, arylene, and alkylarylene. More preferably, R⁴ is a C₁-C₁₀ alkylene (particularly ethylene).

Exemplary bis-silyl aminosilanes which may be used in the present invention include bis-(trimethoxysilylpropyl) amine and bis-(trimethoxysilylpropyl) ethylene diamine.

Bis-silyl polysulfur silanes which may be employed in the present invention include: 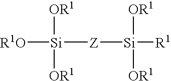
wherein each R¹ is as described before. In the hydrolyzed silane solutions of the present invention, at least a portion (and preferably all or substantially all) of the R¹ groups are replaced by a hydrogen atom. Z is -Q-Sₓ-Q-, wherein each Q is an aliphatic (saturated or unsaturated) or aromatic group, and x is an integer of from 2 to 10. Q within the bis-functional polysulfur silane can be the same or different. In a preferred embodiment, each Q is individually chosen from the group consisting of: C₁-C₆ alkyl (linear or branched), C₁-C₆ alkenyl (linear or branched), C₁-C₆ alkyl substituted with one or more amino groups, C₁-C₆ alkenyl substituted with one or more amino groups, benzyl, and benzyl substituted with C₁-C₆ alkyl.

Particularly preferred bis-silyl polysulfur silanes include bis-(triethoxysilylpropyl) sulfides having 2 to 10 sulfur atoms. Such compounds have the following formula: 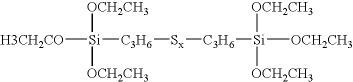
wherein x is an integer of from 2 to 10. One particularly preferred compound is bis-(triethoxysilylpropyl)tetrasulfide (also referred to as bis-(triethoxysilylpropyl)sulfane, or “TESPT”). Commercially-available forms of TESPT are actually mixtures of bis-(triethoxysilylpropyl)sulfides having 2 to 10 sulfur atoms. In other words, these commercially available forms of TESPT have a distribution of sulfide chain lengths, with the S₃ and S₄ sulfides predominating.

The oligomeric silanes for use in the present invention will include, in part, the same organofunctional groups as the monomeric silanes previously discussed. These will have a molecular weight less than about 500. Two preferred oligomeric silanes include aminopropylsilsesquioxane oligomer as well as aminopropylsilsesquioxane-methylsilsequioxane, which is a copolymeric oligomer. Other commercially available oligomers include aminopropylsilsesquioxane-vinylsilsesquioxane.

The silane composition of the present invention is simply added to the coating composition. If the coating composition is an organic solvent based coating, the unhydrolyzed silane is generally preferred, whereas, with water-based coatings, the hydrolyzed silane is added. These can be added either dissolved in a solvent or as 100% solids. Generally, 0.01-5% by volume of the silane (solids) is added to the coating composition. More preferably, the coating composition will contain from about 0.5% to about 2% by volume, with the preferred range being about 0.5-0.5% by volume. Generally, for economic reasons, it is preferred to use as little silane as possible to achieve the desired end result.

Corrosion inhibitors including molybdates, phosphomolybdates, phosphosilicates, borosilicates, benzotriazole and sodium metavanadate can also be added to the coating composition.

The silane and optional corrosion inhibitor are simply blended with the liquid coating composition, which can be used immediately or stored for later use.

The silane-containing coating composition is applied to metal surfaces. The metal is first cleaned, using any typical cleaner, such as a caustic solution. The metal can be any metal subject to oxidation such as steel, including cold rolled steel, galvanized surfaces such as hot-dipped galvanized steel, copper and its alloys, as well as aluminum and it alloys. The metals will generally be untreated other than for the cleaning. However, the present invention will also work on pretreated surfaces, although certain of the economic advantages will not be appreciated when using this on a pretreated surface.

The present invention will be further appreciated in light of the following detailed examples:

### EXAMPLE 1

To form a coating, the individual components were stirred together to form a homogeneous mixture. No induction time is needed. The silane content in wet formulation is 3% by volume. The resulting coating provides (1) excellent corrosion resistance and adhesion to substrates and (2) good weather durability.

| | Volume part |
|---|---|
| Duratop A.C.W. W-1735 AV¹ | 97 |
| Silquest ® A-1289² | 3 |
| Total | 100 |

¹Duratop A.C.W. W-1735 AV: Acrylate latex, available from the Thermoclad Company
²Silquest ® A-1289: bis-triethoxysilylpropyltetrasulfide, available from GE Silicones, www.gesilicones.com

Substrate: Hot-dip galvanized steel, HDG, panels were cleaned with a 7% Chemclean (purchased from Chemetall/Oakite Inc) at 65° C., followed by tap water rinsing and blow air drying.

Application and Cure: A coating of 2 to 5 μm thick was spray-applied onto the cleaned HDG panels. The wet coating cured at 70° C. for 1 hour, followed by 3 days of ambient curing before testing.

Testing: ASTM B117 was conducted on the above panels. The control system was a HDG panel coated with Duratop A.C.W. W-1735 AV without the addition of silane.

Results: The ASTM B117 test was conducted for coatings with and without silanes. The silane-containing coating exhibited no corrosion after 335 hours of salt spray exposure, while the coating without silane exhibited severe corrosion along the edges and the untreated HDG exhibited 100% corrosion after 17 hours of exposure.

### EXAMPLE 2

The following coating is based upon a 2-component formulation as below. Part A was stir mixed with part B at the ratio of 3 to 1 by volume. A homogeneous mixture should be achieved before coating application. No induction time is needed. The potlife of this formulation is 6 hours. The resulting coating provided excellent corrosion resistance and adhesion to substrates and self-healing effect.

| | Volume part |
|---|---|
| Part A | |
| Dupont URO 1104S primer filler¹ | 3 |
| Part B | |
| 7985S Medium activator-reducer² | 1 |
| Silane³ | 0.25-0.5 |
| Corrosion inhibitor(s)⁴ | 0.05-10% of the total formulation |

¹Dupont URO 1104S primer-filler: solventborne polyurethane type of primer, available from Dupont Performance Coatings, Wilmington, DE 19898
²7985S Medium activator-reducer: aliphatic polysocyanate resin, available from Dupont Performance Coatings, Wilmington, DE 19898
³Silanes: bis-methoxysilylpropylamine (Sliquest ® A-1170, available from GE Silicones, www.gesilicones.com
⁴Corrosion inhibitors: nontoxic corrosion inhibitors were tested, such as zinc phosphates.

Substrate: Aluminum alloy, AA 2024-T3, panels were cleaned with a 7% Chemclean (purchased from Chemetall/Oakite Inc.) at 65° C. for 3-5 minutes, followed by tap water rinsing and blow air drying.

Application and Cure: A coating of 30 to 40 μm thick was applied onto the cleaned AA 2024-T3 panels with a #36 draw down bar. The wet coating was ambient cured for one day before testing.

Testing: ASTM B117 and ASTM D3359-B were conducted on the above panels. The control system was a chromated AA 2024-T3 panel coated with the above primer without silane and corrosion inhibitors.

Results: Table 1 presents the benchmark results for the coated AA 2024-T3 panels.

TABLE 1
The benchmark results for the primer-coated AA 2024-T3 panels

| Test | Result |
|---|---|
| ASTM D3359-B (adhesion) | excellent |
| ASTM B117 (salt sprat test) | 1000 hours no severe corrosion and |
| | film delamination |
| | 250 hours no corrosion in the scribe |

Discussion: It is clearly seen from the above results that with the incorporation of a small amount of silane, the paint adhesion to the substrate is greatly enhanced. This leads to the enhancement of corrosion protection performance of polyurethane primer on AA 2024-T3. A composite panel with chromate pretreatment showed some blisters on the surface after 1000 hours of SST, indicating the loss of paint adhesion at some local areas. A comparison panel without pretreatment exhibited severe corrosion and film delamination even after 168 hours of SST.

Although silanes enhance corrosion protection performance of the polyurethane primer by improving the paint adhesion to the substrate, silanes themselves do not possess a self-healing effect as chromates do. Therefore, silanes in the primer do not provide protection on the scribes (or bare metal on the damaged area). To overcome this shortcoming, various corrosion inhibitors were added into the primer along with the silanes. The panels coated with coatings with corrosion inhibitors showed no white rust in the scribes after 250 hours of SST. This indicates that the addition of proper corrosion inhibitors along with silanes, the scribes can be protected.

### EXAMPLE 3

The following is based upon the formulation as below. The individual components were stir-mixed. A homogeneous mixture should be achieved before coating application. No induction time is needed. The silane content in wet formulation is between 2% and 5%. Silanes, such as Z-6020 and AV5, are fitted to this application. The resulting coating provides excellent corrosion resistance and adhesion to substrates.

| | Volume part |
|---|---|
| A solventborne urethane primer | 98 |
| Silane¹ | 2 |
| Total | 100 |

¹Silane is a mixture of bis-trimethoxysilylpropylamine (available from Momentive) and vinylacetoxysilane (available from Dow Corning) at the volume ratio of 5:1.

Substrate: Hot-dip galvanized steel, HDG, panels were cleaned with a 7% Chemclean (from Chemetall/Oakite Inc) at 65° C., followed by tap water rinsing and blow air drying.

Coating Application and Cure: The modified primer of 2 to 5 μm thick was drawn-down onto the cleaned HDG panels. The wet primer cured at 160° C. for 3 minutes. A solvent borne urethane topcoat of 25 μm thick was then drawn-down onto the above primed HDG panels, followed by curing at 160° C. for 20 minutes.

Testing: ASTM B117 was conducted on the above coated panels. The control system was a HDG panel coated with the urethane primer without the addition of silane.

Results: 1000-hour ASTM B117 test results were obtained for the HDG panels coated with the urethane primers with and without silane addition. The panel coated with the silane modified urethane primer performs significantly better than the one without silane addition. The former shows less than 1 mm creep along the scribes after 1000 hours in SST, while the latter shows a complete delamination after 200 hours in SST.

In the above example, the selected silane can be replaced with AMME oligomer 22-25%, available from Gelest, Inc.

By use of the present invention, one can avoid the use of phosphates or zirconium based or chromium based pretreatments and achieve corrosion prevention. Further, this enhances adhesion of the polymeric coating composition onto the untreated metal surface.

This has been a description of the present invention along with the preferred method of practicing the present invention. However, the invention itself should only be defined by the appended claims, WHEREIN WE CLAIM.

What is claimed is:

1. A coating composition comprising a polymerizable coating composition in combination with a silane compound;
said silane compound comprising an organofunctional silane selected from the group consisting of bis-functional silanes, polysulfur silanes, blends of amino silanes and vinyl silanes, vinyl silanes, glycidal silanes, ureido silanes and isocyanato silanes, and combinations thereof.

2. The coating composition claimed in claim 1 wherein said bis-functional silane compound comprises from 0.01 to 5% by volume of said coating composition.

3. The coating composition claimed in claim 2 wherein said silane is a bis-functional silane.

4. The coating composition claimed in claim 1 wherein said silane comprises a mixture of silanes.

5. A metal surface coated with the coating composition of claim 1.

6. The metal surface claimed in claim 5 wherein said metal surface is not pretreated with a phosphate, zirconium, or chromium pretreatment.

7. The composition claimed in claim 1 further comprising a corrosion inhibitor.

8. The composition claimed in claim 7 wherein said corrosion inhibitor is selected from the group consisting of molybdates, phosphomolybdates, phosphosilicates, borosilicates, benzotriazole and sodium metavanadate.

9. A method of coating a metal surface comprising cleaning said metal surface to form a cleaned metal surface, applying to said cleaned metal surface, and without prior pretreatment for corrosion inhibition, a coating composition comprising a polymerizable coating composition in combination with a silane compound
said silane compound comprising an organofunctional silane selected from the group consisting of monomeric silanes, oligomeric silanes, and combinations thereof.

10. The method claimed in claim 9 wherein said silane compound comprises 0.01 to 5% by volume of said coating composition.

11. The method claimed in claim 9 wherein said silane includes one or more organofuntional groups selected from the groups consisting of amino, vinyl, sulfur, urethane, epoxy, methacril, isocyanate and acryl functionalities.

12. The method claimed in claim 9 wherein said silane is a bis-functional silane.

13. The method claimed in claim 9 wherein said silane comprises a mixture of vinyl and amino silanes.

14. The method claimed in claim 9 wherein said silane is a silsesquioxane.

15. The method claimed in claim 14 wherein said silsequioxane includes an organofunctional group selected from the group consisting of amino, vinyl, urethane, isocyanato and sulfur.
